(19) United States
(12) Patent Application Publication
(10) Pub. No.: US 2009/0183115 A1
(43) Pub. Date: Jul. 16, 2009

(54) Document searching apparatus, document searching method, and computer-readable recording medium

(75) Inventor: Masajiro Iwasaki, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/318,246

(22) Filed: Dec. 23, 2008

(30) Foreign Application Priority Data
Jan. 11, 2008 (JP) 2008-004802

(51) Int. Cl. G06F 7/06; G06F 17/30; G06F 3/048

(52) U.S. Cl. 715/810; 707/3; 707/E17.008

(57) ABSTRACT

A document searching apparatus includes an element-correspondence storing unit that stores therein a page-correspondence managing table in which document data is associated with each page making up the document data, a searching unit that searches the page-correspondence managing table for pages satisfying a search criterion, a document identifying unit that identifies document data associated with the retrieved pages, a collating unit that groups the retrieved pages according to the identified document data, and a display processing unit that displays the pages grouped by document data.

### CROSS-REFERENCE TO RELATED APPLICATIONS

The present application claims priority to and incorporates by reference the entire contents of Japanese priority document 2008-004802 filed in Japan on Jan. 11, 2008.

### BACKGROUND OF THE INVENTION

1. Field of the Invention

The present invention relates to a technology for displaying retrieved documents.

2. Description of the Related Art

In recent years, an increasing number of documents are converted into electronic form because of the development of computer-related technology and the enhancement and spread of network environments. This is promoting paperless environments in many offices.

Workers working in an office produce various documents as electronic documents on their personal computers (PCs). Then, those electronic documents are edited, copied, transmitted, and shared on a PC or a server. If the PC or the server that stores therein those documents is connected to a second PC via a network, the electronic documents can also be browsed, edited, and so forth using the second PC.

In such an office environment, it is difficult to manage those individual electronic documents in a unified way because many workers produce electronic documents using many PCs. As a result, the workers sometimes get confused. For example, an electronic document needed by a worker cannot be found because the user does not know how and in which PC the electronic document is stored. To overcome this problem, some document management systems have been proposed.

For example, Japanese Patent Application Laid-open No. H11-120202 describes a system that stores therein scanned documents, facsimile documents, electronic documents produced with applications, WWW documents, and so forth such that the original data, a text file, a thumbnail of each page, and so forth are associated with one another for each document. By doing so, when a search is made for an electronic document, the thumbnail of each page of the electronic document can be displayed as required. However, this system is disadvantageous in that when a user searches for a plurality of items of document data and displays document data on a page-by-page basis, the user feels difficulty in finding desired pages because many pages are usually displayed.

### SUMMARY OF THE INVENTION

It is an object of the present invention to at least partially solve the problems in the conventional technology.

According to an aspect of the present invention, there is provided a document searching apparatus including a correspondence storing unit that stores therein document information and a plurality of elements constituting the document information in an associated manner; a searching unit that retrieves at least one element satisfying a search criterion from among the elements stored in the correspondence storing unit; a document identifying unit that identifies document information associated with each of the elements retrieved by the searching unit; a collating unit that groups each of the elements retrieved by the searching unit according to the document information identified by the document identifying unit; and a display processing unit that displays each of the elements grouped by the collating unit according to the document information.

According to another aspect of the present invention, there is provided a document searching apparatus including means for storing therein document information and a plurality of elements constituting the document information in an associated manner; means for searching and retrieving at least one element satisfying a search criterion from among the elements stored in the means for storing; means for identifying document information associated with each of the elements retrieved by the means for searching and retrieving; means for grouping each of the elements retrieved by the means for searching and retrieving according to the document information identified by the means for identifying; and means for processing and displaying each of the elements grouped by the means for grouping according to the document information.

According to still another aspect of the present invention, there is provided a computer readable recording medium that stores therein a computer program which when executed on a computer causes the computer to execute storing document information and a plurality of elements constituting the document information in a storing unit in an associated manner; searching and retrieving at least one element satisfying a search criterion from among the elements stored in the storing unit at the storing; identifying document information associated with each of the elements retrieved at the searching and retrieving; grouping each of the elements retrieved at the searching and retrieving according to the document information identified at the identifying; and processing and displaying each of the elements grouped at the grouping according to the document information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an exemplary structure of a document searching apparatus according to a first embodiment of the present invention;

FIG. 2 is a diagram of an exemplary table structure of a document managing table shown in FIG. 1;

FIG. 3 is a diagram of an exemplary table structure of a page-correspondence managing table shown in FIG. 1;

FIG. 4 depicts a first example of conditions for deleting some of the pages found by a searching unit shown in FIG. 1;

FIG. 5 depicts a second example of conditions for deleting some of the pages found by the searching unit;

FIG. 6 depicts a third example of conditions for deleting some of the pages found by the searching unit;

FIG. 7 depicts a fourth example of conditions for deleting some of the pages found by the searching unit;

FIG. 8 is a diagram of an exemplary search screen displayed by a display processing unit shown in FIG. 1;

FIG. 9 is a diagram of a conventional page-search-result screen;

FIG. 10 is a diagram depicting a first example of a search result displayed by the display processing unit;

FIG. 11 is a diagram depicting a second example of a search result displayed by the display processing unit;

FIG. 12 is a diagram depicting a first example of a page list displayed by a list-display processing unit shown in FIG. 1;

FIG. 13 is a diagram depicting a second example of a page list displayed by the list-display processing unit;

FIG. 14 is a diagram depicting a third example of a page list displayed by the list-display processing unit;

FIG. 15 is a diagram depicting a third example of a search result displayed by the display processing unit;

FIG. 16 is a diagram depicting a fourth example of a search result displayed by the display processing unit;

FIG. 17 is a diagram depicting a fourth example of a page list displayed by the list-display processing unit;

FIG. 18 is a diagram depicting an exemplary screen of a page list after being subjected to magnified display by the list-display processing unit;

FIG. 19 is a flowchart illustrating a procedure for searching for document data performed by the document searching apparatus shown in FIG. 1;

FIG. 20 is a block diagram of an exemplary structure of a document searching apparatus according to a second embodiment of the present invention;

FIG. 21 is a diagram of an exemplary table structure of an area-correspondence managing table shown in FIG. 20;

FIG. 22 is a diagram of an exemplary page list displayed by the list-display processing unit shown in FIG. 1; and

FIG. 23 is a diagram of an exemplary hardware structure of a PC that executes a program that achieves the functions of the document searching apparatuses according to the first and the second embodiments.

### DETAILED DESCRIPTION OF THE PREFERRED EMBODIMENTS

Exemplary embodiments according to the present invention will now be described in detail with reference to the attached drawings.

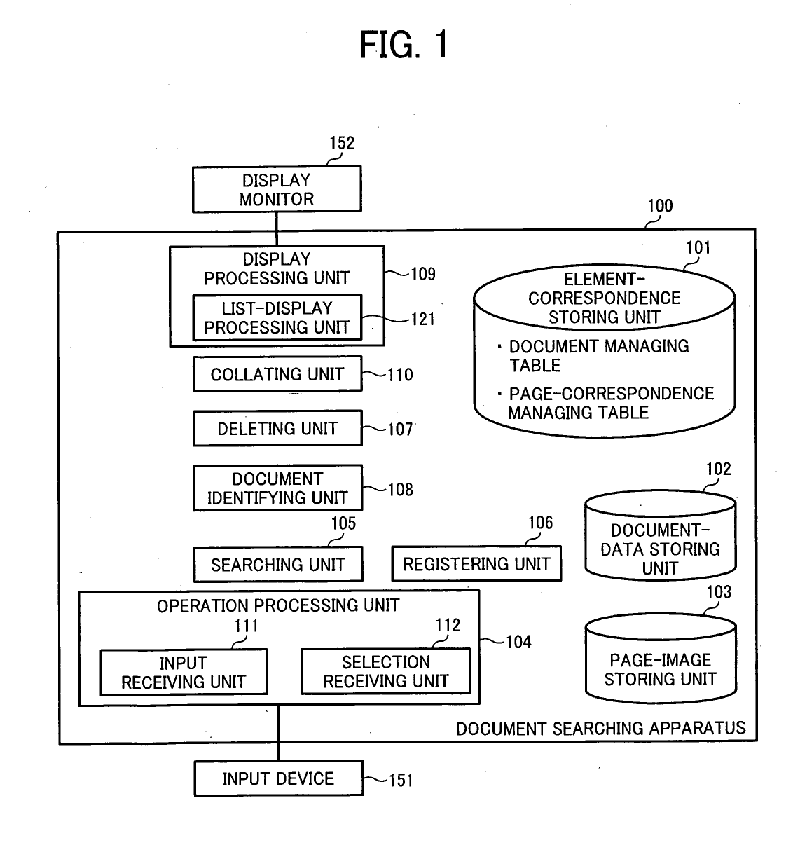

FIG. 1 is a block diagram of an exemplary structure of a document searching apparatus 100 according to a first embodiment of the present invention. This document searching apparatus 100 includes an element-correspondence storing unit 101, a document-data storing unit 102, a page-image storing unit 103, an operation processing unit 104, a searching unit 105, a registering unit 106, a deleting unit 107, a document identifying unit 108, a display processing unit 109, and a collating unit 110 to allow document data to be registered, managed, retrieved, and so forth. The document searching apparatus 100 is connected to a display monitor 152 and an input device 151.

Document data to be managed by the document searching apparatus 100 includes document images where characters are also represented as an image, as well as electronic documents that are produced with document-creating applications.

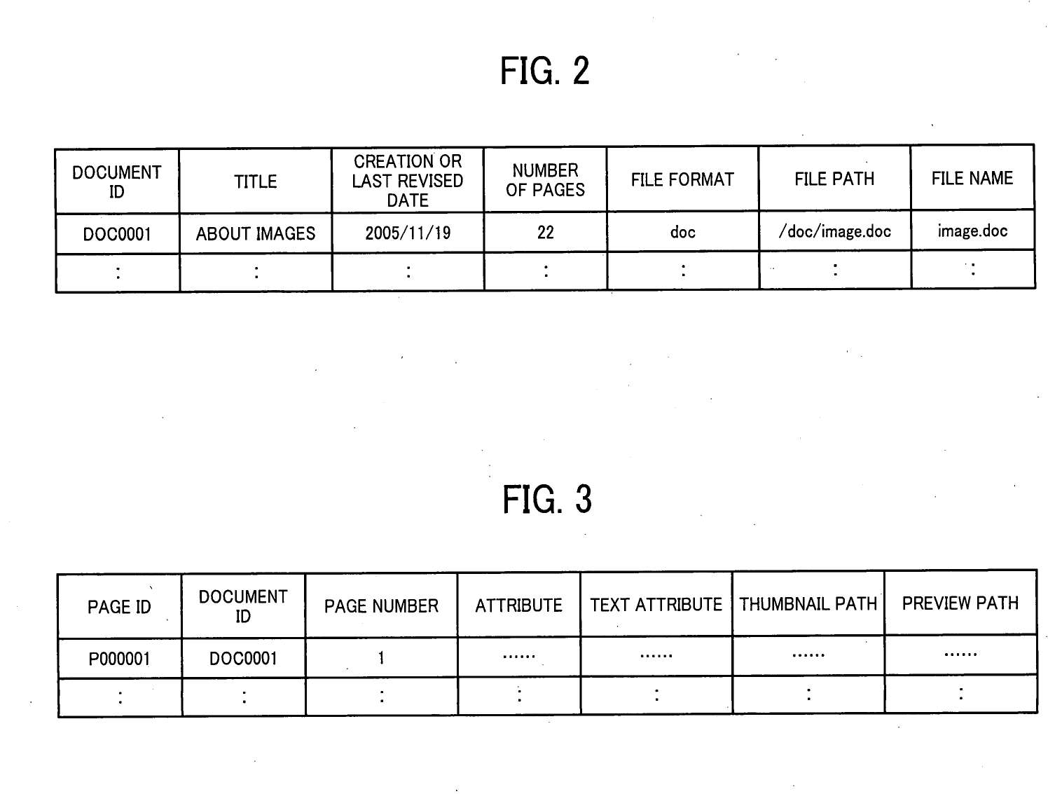

The element-correspondence storing unit 101 stores therein a document managing table and a page-correspondence managing table. FIG. 2 is a diagram of an exemplary table structure of the document managing table. The document managing table stores therein a document ID, a title, a creation or last revised date, the number of pages, a file format, a file path, and a file name in an associated manner.

The document ID is a unique ID assigned to each item of document data and can be used to identify particular document data. The title is the title of the document data. The creation or last revised date indicates the creation date or the last revised date of the document data. The number of pages indicates the number of pages contained in the document data. The file format indicates the format of the document data. The file format can be used to identify whether the relevant managed document is a scanned document, a facsimile document, an electronic document produced with an application, or a WWW document. The file path indicates the location where the document data is stored. The file name indicates the file name of the document data.

FIG. 3 is a diagram of an exemplary table structure of the page-correspondence managing table. The page-correspondence managing table stores therein a page ID, a document ID, a page number, an attribute, a text attribute, a thumbnail path, and a preview path such that these items are associated with one another.

The page ID is a unique ID assigned to each page making up the document data and can be used to uniquely identify a particular page of the document data managed by the document searching apparatus 100. The document ID is an ID for identifying the document data containing the relevant page. The page number is the page number of the relevant page in the document data containing the relevant page. The attribute indicates a characteristic extracted from the image representing the relevant entire page.

The text attribute indicates characteristics extracted from text information contained in the relevant page, such as a keyword and its frequency in the text information. If the document data is a document image, the text attribute can be extracted from text information that has been extracted from the document image of the relevant page by OCR. The thumbnail path indicates the location where a thumbnail representing the entire screen is stored. The preview path indicates the location where a preview image representing the entire screen is stored.

The document-data storing unit 102 stores therein document data and a thumbnail representing the relevant document. The page-image storing unit 103 stores therein a preview image representing each page of the document data and a thumbnail representing each page of the document data. The element-correspondence storing unit 101, the document-data storing unit 102, and the page-image storing unit 103 can be realized by any type of commonly used storage unit, such as a hard disk drive (HDD), an optical disk, a memory card, or a random access memory (RAM).

The registering unit 106 performs registration of document data to be searched. For this purpose, the registering unit 106 registers document data in the document-data storing unit 102, and registers page-image data and a thumbnail generated from each page of the relevant document data in the page-image storing unit 103. Furthermore, the registering unit 106 registers information about the relevant document data and each page in the document managing table and the page-correspondence managing table.

The operation processing unit 104 includes an input receiving unit 111 and a selection receiving unit 112 and processes operations input from the input device 151.

The input receiving unit 111 receives input of a search criterion from a user via the input device 151. This input of a search criterion can be performed, for example, on a search screen that is initially displayed, as well as on a search-result screen to be displayed after a search operation has been completed.

The selection receiving unit 112 receives selection of document data from a user from among a plurality of items of document data displayed by the display processing unit 109 on the display monitor 152.

The searching unit 105 searches at least one of the document managing table and the page-correspondence managing table according to the search criterion input by the input receiving unit 111. The searching unit 105 can search for particular document data or for a particular page contained in a specific document data.

If the search criterion for pages includes a plurality of character strings, the searching unit 105 searches for pages containing at least one of the input character strings. More specifically, the searching unit 105 searches the field “text attribute” of the page-correspondence managing table for at least one of a plurality of character strings specified as a search criterion and finds the page IDs, the page numbers, the document IDs, and the thumbnail paths of the records that satisfy the search criterion.

When the searching unit 105 searches for pages, the document identifying unit 108 identifies the document data containing each found page. The document data containing the relevant page can be identified based on the document ID associated with the page ID in the page-correspondence managing table. By doing so, the found pages can be displayed separately for each item of document data.

If the character strings input as a search criterion are distributed on different pages of the document data identified by the document identifying unit 108 and if the distance (i.e., difference), represented by page number, between the pages is larger than a predetermined value, then the deleting unit 107 deletes the pages from the search result produced by the searching unit 105. In the first embodiment, if the page distance is more than two pages, the relevant pages are deleted. However, this predetermined page distance can be changed as required.

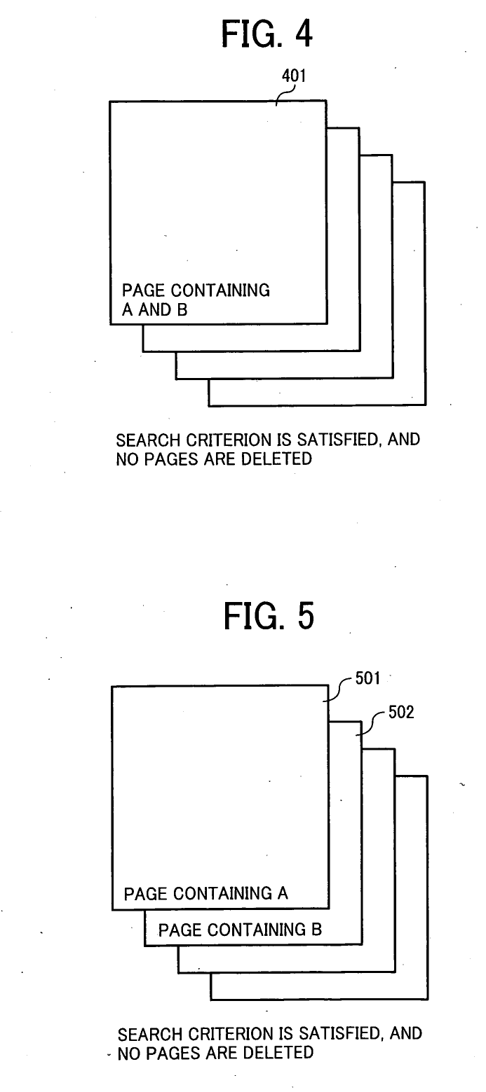

FIGS. 4 to 7 are examples of conditions for deleting some of the pages found by the searching unit 105. In FIGS. 4 to 7, it is assumed that a character string ‘A’ and a character string ‘B’ have been input as a search criterion.

In the example shown in FIG. 4, a page 401 contains a character string ‘A’ and a character string ‘B’. Because the distance between the page containing the character string ‘A’ and the page containing the character string ‘B’ is within two pages, the deleting unit 107 does not delete the page 401.

In the example shown in FIG. 5, a page 501 contains a character string ‘A’, and a page 502 subsequent to the page 501 contains a character string ‘B’. In this case, the distance between the page 501 and the page 502 is within two pages. Therefore, the deleting unit 107 does not delete the pages 501 and 502.

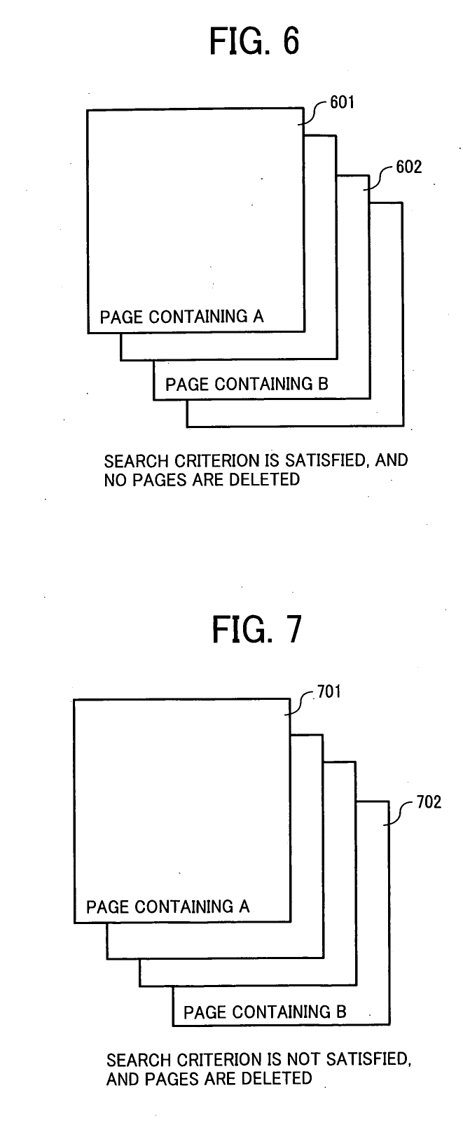

In the example shown in FIG. 6, a page 601 contains a character string ‘A’, and a page 602, two pages ahead of the page 601, contains a character string ‘B’. In this case, the distance between the page 601 and the page 602 is within two pages, and therefore, the deleting unit 107 does not delete the pages 601 and 602.

In the example shown in FIG. 7, a page 701 contains a character string ‘A’, and a page 702, three pages ahead of the page 701, contains a character string ‘B’. In this case, the distance between the page 701 and the page 702 is larger than two pages, and therefore, the deleting unit 107 deletes the pages 701 and 702.

In other words, when a user searches for pages by specifying a character string ‘A’ and a character string ‘B’ as a search criterion, no pages are regarded as satisfying the search criterion as long as these character strings ‘A’ and ‘B’ are distributed on a plurality of pages. However, these pages can provide information useful to the user as long as the character string ‘A’ and the character string ‘B’ exist close to each other.

On the other hand, if a user searches for document data by specifying a character string ‘A’ and a character string ‘B’ as a search criterion, although document data containing these pages can be found, the user further needs to search the relevant document data by specifying these character strings as a search criterion to know which pages of the found document data contain the character string ‘A’ or the character string ‘B’. For a search operation for document data, document data can be retrieved even if a character string ‘A’ is contained on one page and a character string ‘B’ on another. This may not be very useful to the user.

In light of these circumstances, the document searching apparatus 100 is designed such that when a plurality of character strings are specified as a search criterion, pages containing these character strings are retrieved if the distance between the pages is within two pages. By doing so, the user can be presented with pages related to these character strings, even if the pages do not contain these character strings.

The collating unit 110 classifies the pages after deletion has been performed by the deleting unit 107 according to document data identified by the document identifying unit 108.

The display processing unit 109 includes a list-display processing unit 121 and displays information on the display monitor 152. The display processing unit 109 displays a document-search screen and a search-result screen on the display monitor 152. For example, the display processing unit 109 displays on the display monitor 152 a group of pages combined by the collating unit 110 for each item of document data. The display processing unit 109 may display these screens in a Web browser.

When the display processing unit 109 displays pages, classified by each item of document data, and the selection receiving unit 112 receives the selection of document data, the list-display processing unit 121 displays a list of pages contained in the selected document data on the display monitor 152.

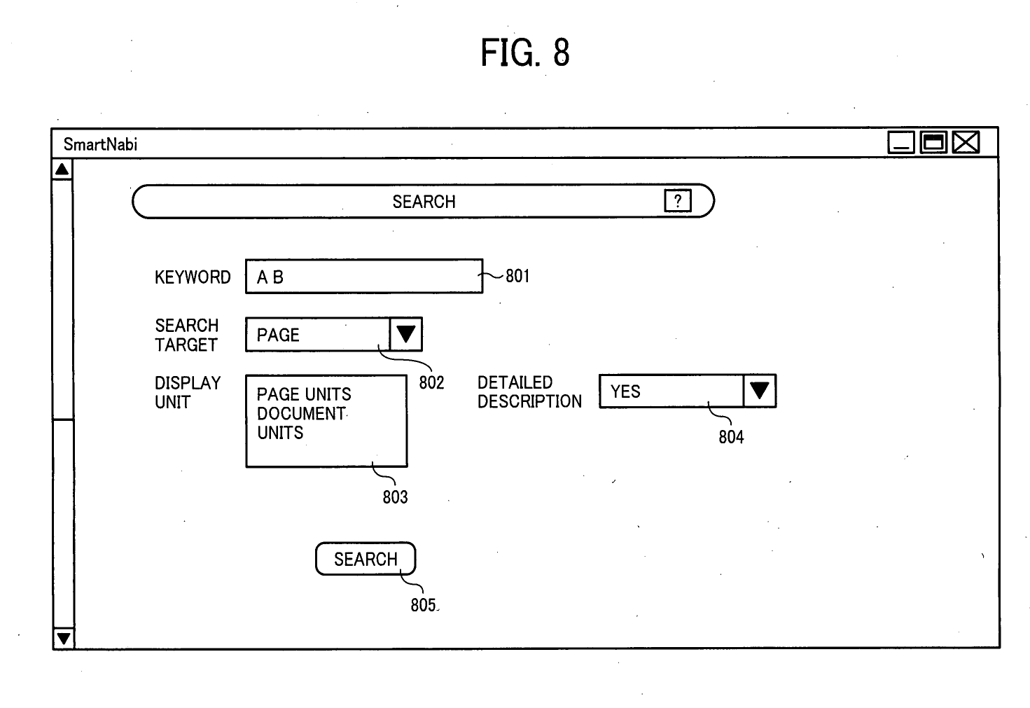

FIG. 8 is a diagram of an exemplary search screen displayed by the display processing unit 109 on the display monitor 152. Referring to FIG. 8, the user inputs a character string, serving as a search key, in a keyword entry window 801. The user selects pages or document data as a search target in a search target entry window 802. This embodiment will be described assuming that the user selects pages in a search target entry window 802. The user selects whether a search result should be displayed in page units or document units in a display unit entry window 803. The user selects, in a detailed description entry window 804, whether a detailed description of document data or pages should be displayed when a search result is displayed. Pressing of a search button 805 starts a search operation.

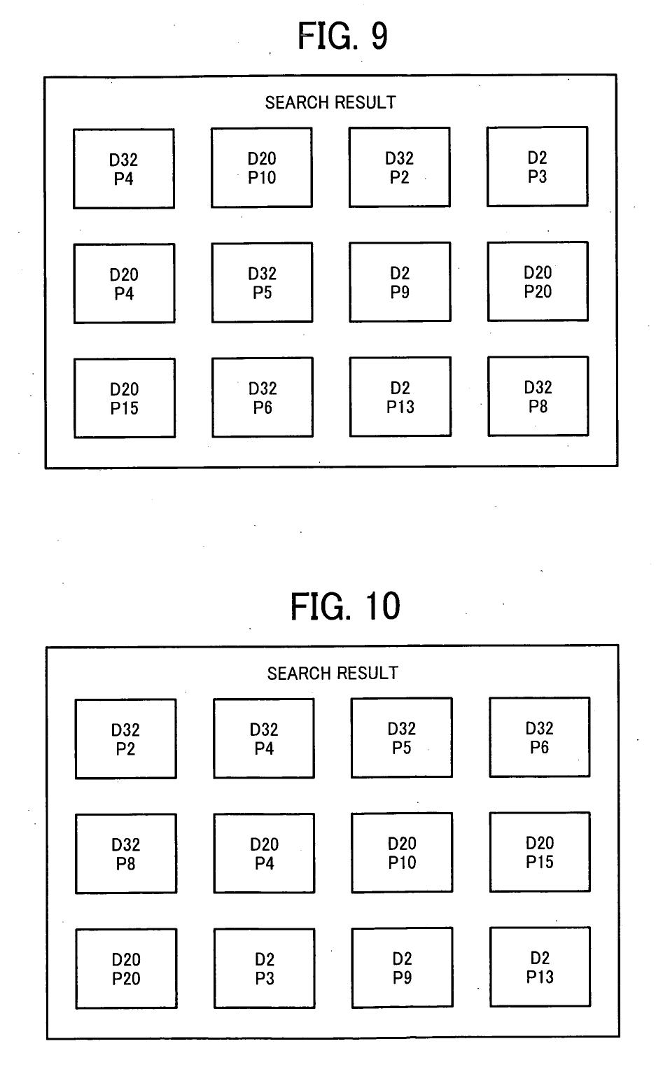

A conventional search result will now be described. FIG. 9 is a diagram of a conventional page-search-result screen. Referring to FIG. 9, “D+number” denotes the name of document data, and “P+number” denotes a page number. For the conventional search result of pages, pages satisfying the search criterion are displayed regardless of whether those pages are contained in the same document data. If this is the case, the user cannot grasp the relationships of the pages displayed as a search result.

To overcome this problem, in the document searching apparatus 100, the pages meeting the search criterion are displayed, classified according to document data.

FIG. 10 is a diagram depicting a first example of a search result displayed by the display processing unit 109 on the display monitor 152. To display the search result, it is assumed that the display units are set to “Page units” and the detailed description is set to “No” on the search screen (see FIG. 8). In the search result shown in FIG. 10, pages contained in document data D32, D20, and D2 are displayed in order of page number, classified according to document data.

In the example shown in FIG. 10, pages, even if contained in the same document data, are displayed side by side on the screen. Because of this, when many items of document data meet the search criterion, the user feels difficulty in browsing the pages. To overcome this problem, a technique for displaying pages when many items of document data meet the search criterion will be described.

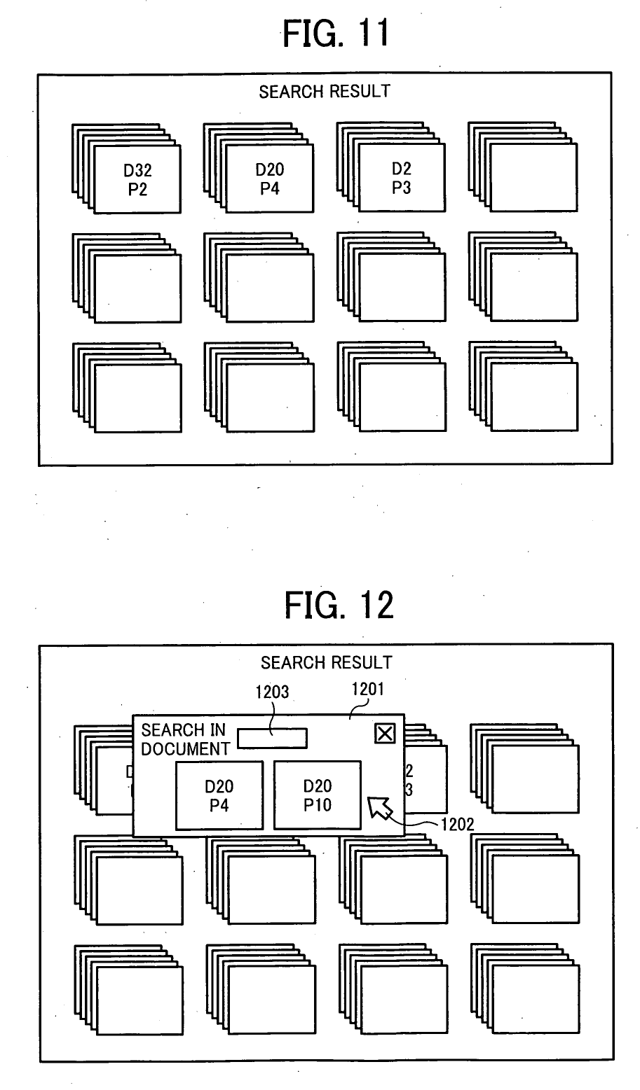

FIG. 11 is a diagram depicting a second example of a search result displayed by the display processing unit 109. To display the search result, it is assumed that the display units are set to “Document units” and the detailed description is set to “No” on the search screen (see FIG. 8). In the search result shown in FIG. 11, pages are cascaded, classified according to document data (D32, D20, and D2).

In the example shown in FIG. 11, the image data of the page having the smallest page number in each item of document data can be viewed. As a result, the user can probably identify his/her desired document data.

Furthermore, from among the retrieved pages, the display processing unit 109 may display the front page (instead of the page having the smallest page number) of the document data as the foremost page. In addition, the display processing unit 109 may cascade all pages (instead of just the pages meeting the search criterion) of document data and may allow the user to identify the pages meeting the search criterion in some way. Any technique can be used to identify the pages meeting the search criterion. Examples of techniques for identifying particular pages include displaying those pages in color. Furthermore, the display processing unit 109 may provide a switching button for selecting whether to display all pages or to display only pages meeting the search criterion when the operation processing unit 104 receives the button operation.

Next, an operating procedure for displaying each of the pages, classified by document data, as shown in FIG. 11, will be described. In this case, the user points to desired document data using the input device 151. As a result, the list-display processing unit 121 displays each of the pages grouped in the document data.

FIG. 12 is a diagram depicting a first example of a page list displayed by the list-display processing unit 121. Referring to FIG. 12, when the document data D20 is selected with a cursor 1202, the list-display processing unit 121 displays two pages (page P4 and page P10) making up the document data D20 in a window 1201. In this manner, only the pages retrieved as a result of a search operation are displayed in the window 1201. Other pages can be viewed upon receiving input of a paging operation. Thus, when the list-display processing unit 121 receives input of a paging operation, it displays the subsequent or previous page. In addition, the list-display processing unit 121 is not limited to displaying only the pages retrieved as a result of a search operation but can also display, for example, all pages of the document data selected by the user and highlight only the pages retrieved as a result of a search operation from among all the pages.

The window 1201 further contains a search in document box 1203 to allow the user to search the document data D20 for particular pages. For this document search operation, the user can search for particular pages from among only the pages retrieved as a result of the previous document search operation or can search for particular pages from among all pages of the document.

On the exemplary screen shown in FIG. 12, when pages subsequent to page P10 are to be displayed, the user clicks page P10 with the cursor 1202. The list-display processing unit 121 then moves the foremost page to the rearmost position, thereby displaying the second-foremost page. Furthermore, the list-display processing unit 121 may cascade pages in the window 1201 so that the user can click a visible portion of the desired page to pop up the page to the foremost position.

As described above, when the user performs processing such as a mouse-over operation or a double-click operation on document data displayed by the display processing unit 109, the list-display processing unit 121 displays the pages of the selected document data in a double-page format. Subsequently, a click operation, for example, causes the current page to be turned over.

The page listing technique is not limited to that shown in FIG. 12; various other techniques can be employed. Examples of other page listing techniques will be described.

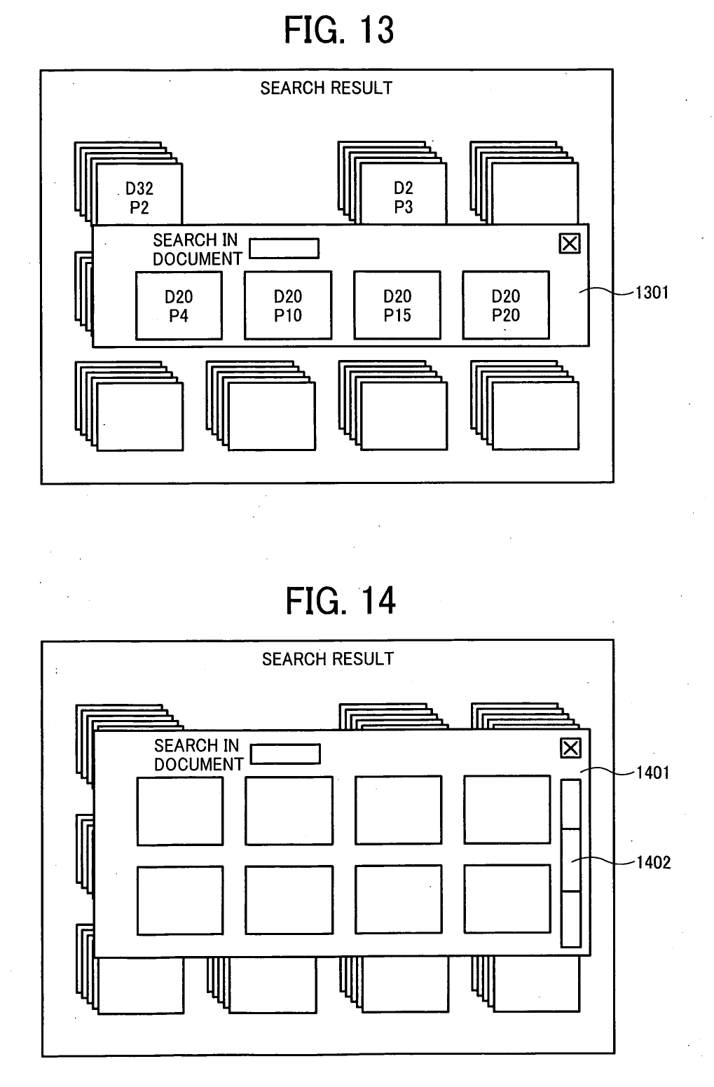

FIG. 13 is a diagram depicting a second example of a page list displayed by the list-display processing unit 121. Thumbnail images corresponding to four pages are displayed in a window 1301. In the exemplary screen shown in FIG. 13, the window size is changed depending on the number of pages grouped as a search result.

FIG. 14 is a diagram depicting a third example of a page list displayed by the list-display processing unit 121. In a window 1401 shown in FIG. 14, a large number of pages meeting the search criterion are contained in the document data. In this case, the list-display processing unit 121 provides a scroll bar 1402. With this scroll bar 1402, the user can scroll up or down to view thumbnails corresponding to all pages meeting the search criterion.

Furthermore, to display information other than the thumbnail of each page, the user just needs to set the detailed description to “Yes” on the search screen. By doing so, the document title, the page number, the file format, and so forth can be displayed.

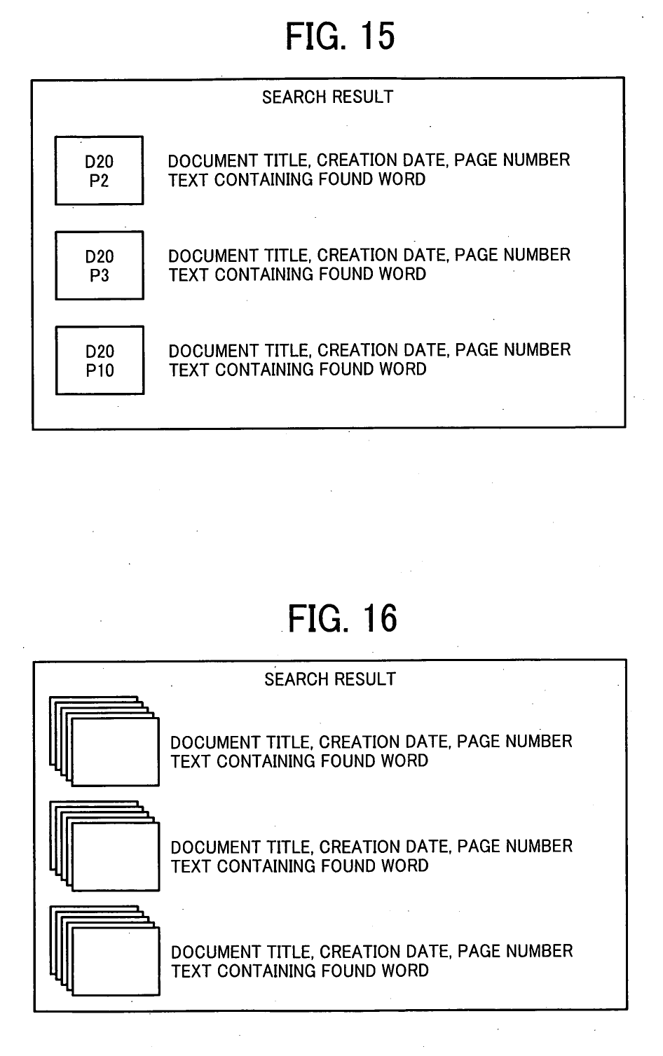

An example of display of a search result will be described. FIG. 15 is a diagram depicting a third example of a search result displayed by the display processing unit 109. To display the search result, it is assumed that the display units are set to “Page units” and the detailed description is set to “Yes” on the search screen (see FIG. 8). In the search result shown in FIG. 15, pages grouped by document data are displayed in order of page number. The display processing unit 109 displays detailed information about each page. Examples of the detailed information displayed by the display processing unit 109 include the document title, the creation date, the page number, and text containing a matching character string (word). For this text display, the matching character string, for example, may be highlighted.

FIG. 16 is a diagram depicting a fourth example of a search result displayed by the display processing unit 109. To display the search result, it is assumed that the display units are set to “Document units” and the detailed description is set to “Yes” on the search screen (see FIG. 8). In the search result shown in FIG. 16, pages are cascaded, grouped by document data. The display processing unit 109 displays detailed information about each item of document data. Examples of the detailed information displayed by the display processing unit 109 include the document title, the creation date, the page number, and text containing a matching character string (word).

When pages are grouped by document data, as shown in FIG. 16, a page list can also be displayed. The operation in this case is the same as that described above, and a description thereof will be omitted.

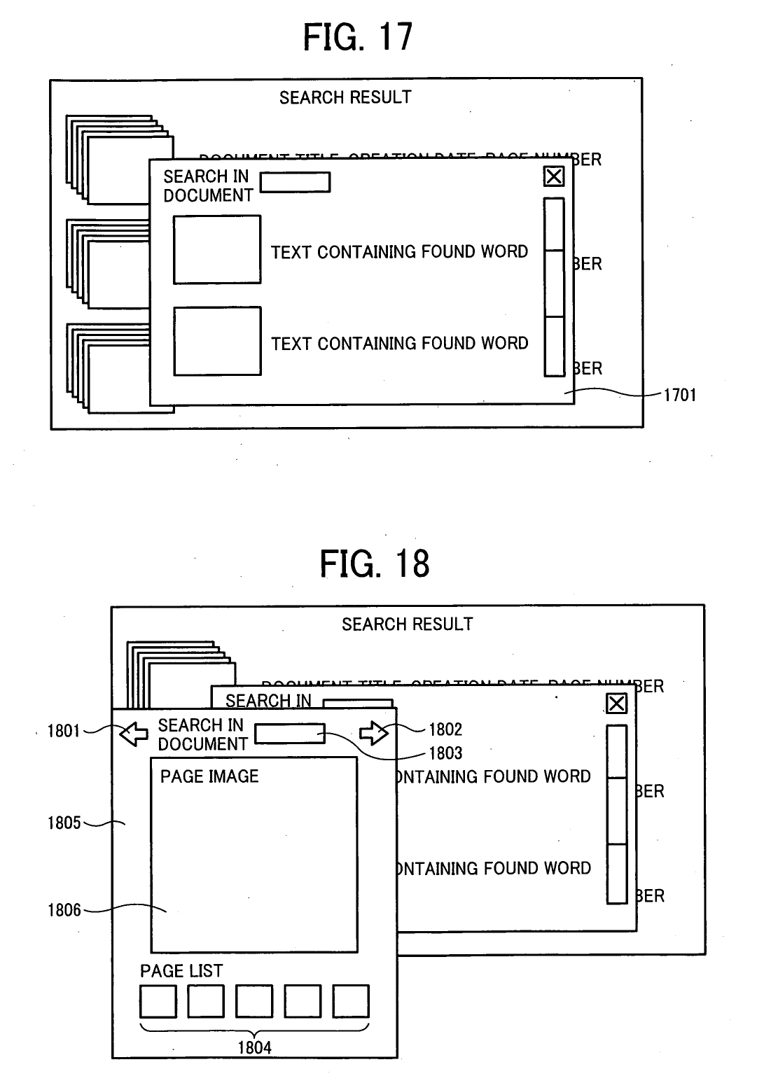

FIG. 17 is a diagram depicting a fourth example of a page list displayed by the list-display processing unit 121. Referring to FIG. 17, the list-display processing unit 121 displays in a window 1701 the thumbnail and detailed information corresponding to each of the pages meeting the search criterion. The screen format shown in FIG. 13 may be used instead of the screen format shown in FIG. 17 for display.

In addition, on the screen shown in FIG. 13 or 17, when the operation processing unit 104 receives selection of any thumbnail and a mouse wheel operation on that thumbnail, the list-display processing unit 121 magnifies the thumbnail for display. Next, an exemplary screen that has been subjected to magnified display will be described.

FIG. 18 is a diagram depicting an exemplary screen of a page list after being subjected to magnified display by the list-display processing unit 121. In the example shown in FIG. 18, the list-display processing unit 121 displays a page list 1804 in the lower part of a window 1805. The list-display processing unit 121 displays a magnified page image 1806. Another page can be magnified for display by selecting a page from the page list 1804 or pressing previous page 1801 or next page 1802. Furthermore, a search box 1803 can also be displayed in the window 1805 to allow the user to search for any page.

In this embodiment, when the input receiving unit 111 receives input of a character string into the search box 1803 in the document, the searching unit 105 narrows down to the pages containing the input character string from among the list of pages displayed in the window 1805. By doing so, pages that are more suitable for the user can be displayed.

Furthermore, the search technique utilizing the search in document box is not limited to that described above. Instead, the searching unit 105 may search the element-correspondence storing unit 101 so that all pages containing the character string input into the search in document box can be displayed.

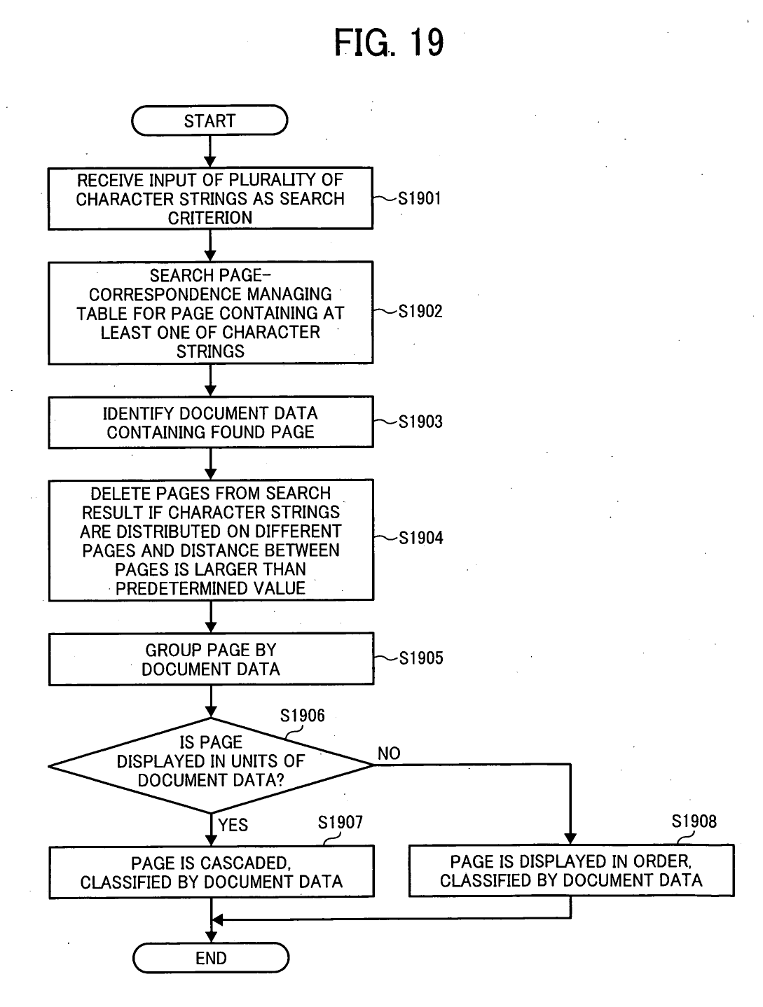

Next, document search processing in the document searching apparatus 100 with the structure described above will be described. FIG. 19 is a flowchart illustrating a procedure for the processing described above in the document searching apparatus 100. It is assumed that the user inputs a plurality of character strings as a search criterion.

First, the input receiving unit 111 receives input of a plurality of character strings as a search criterion on the search screen (Step S1901).

Next, the searching unit 105 searches the page-correspondence managing table for pages containing at least one of the input character strings in the text attribute (Step S1902). Then, the searching unit 105 acquires the page IDs, the page numbers, the document IDs, and the thumbnail paths of the found records.

Subsequently, the document identifying unit 108 identifies the document data containing the found pages based on the acquired document IDs (Step S1903).

Next, if a plurality of character strings appear on different pages in document data identified by the document identifying unit 108 and the distance (in terms of number of pages) between the pages is larger than a predetermined value, the deleting unit 107 deletes these pages from the search result produced by the searching unit 105 (Step S1904). This embodiment assumes that the predetermined distance is two pages.

Then, the collating unit 110 classifies the pages produced as a search result after the deleting unit 107 has performed the deletion, according to document data identified by the document identifying unit 108 (Step S1905).

Thereafter, the display processing unit 109 determines whether to display data in units of document data based on the display units set on the search screen (Step S1906). More specifically, it is determined that data is displayed in units of document data if the display units are set to Document units on the search screen, and it is determined that data is displayed in units of pages if the display units are set to Page units.

If it is determined that the display processing unit 109 displays data in units of document data (YES at Step S1906), the pages grouped by document data are cascaded (Step S1907). An exemplary screen in this case is the one shown in FIG. 11 or the one shown in FIG. 16.

On the other hand, if it is determined that the display processing unit 109 does not display data in units of document data (NO at Step S1906), the thumbnail corresponding to each of the pages, classified by document data, is displayed in order of page number (Step S1908). An exemplary screen in this case is the one shown in FIG. 10 or the one shown in FIG. 15.

With the processing procedure described above, the document searching apparatus 100 can present the user with pages, classified by document data.

Because the document searching apparatus 100 according to this embodiment displays elements, such as pages, grouped by document data, data can be browsed more efficiently.

The first embodiment has been described by way of example of a standalone apparatus that searches for documents. However, the operation processing unit and the display processing unit (GUI screen) may be realized in a client, whereas the other components may be realized in a Web applications server, to build a so-called client/server system.

Although the first embodiment has been described by way of an example where a character string is input as a search criterion, the technique for searching for document data is not limited to string searching; various searching techniques, including image searching, can be employed.

In addition, when a plurality of character strings are set as a search criterion, pages are retrieved if they are within a predetermined distance of each other. Therefore, it becomes easy to find related elements. In addition, even if data is distributed in two or more elements such as pages, the data can be found easily. Furthermore, when a search operation is performed in units of elements such as pages, desired information can be identified efficiently.

The first embodiment has been described by way of an example where the search target is pages. However, the elements to be searched are not limited to pages. In light of this circumstance, a second embodiment will be described by way of an example where an area in a page can be selected as an element to be searched.

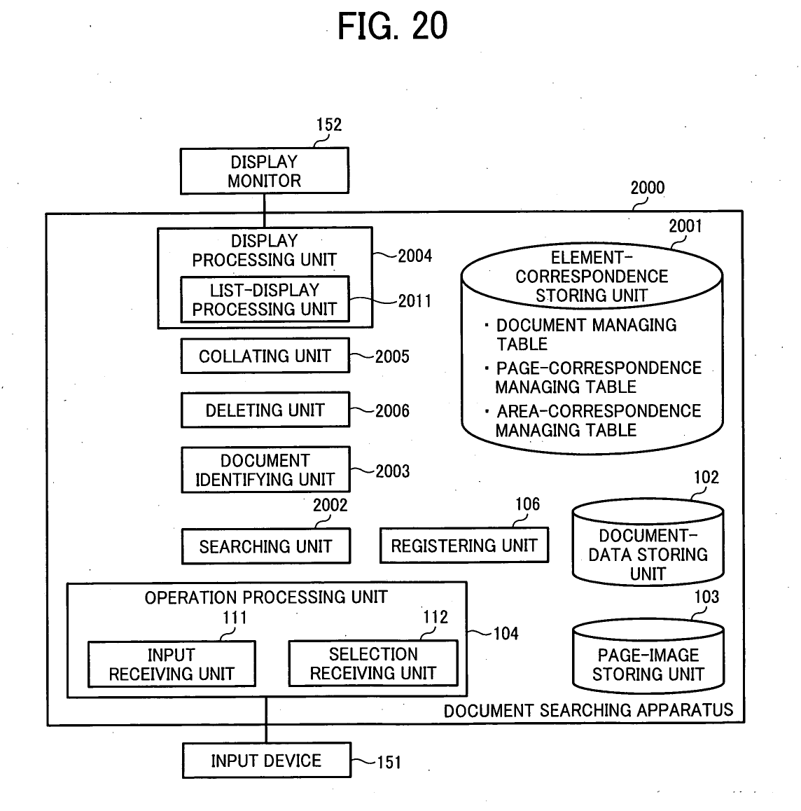

FIG. 20 is a block diagram of an exemplary structure of a document searching apparatus 2000 according to the second embodiment. The document searching apparatus 2000 shown in FIG. 20 differs from the document searching apparatus 100 according shown in FIG. 1 in the following points: an element-correspondence storing unit 2001 additionally includes an area-correspondence managing table; the searching unit 105 is replaced with a searching unit 2002 that performs different processing; the document identifying unit 108 is replaced with a document identifying unit 2003 that performs different processing; the deleting unit 107 is replaced with a deleting unit 2006 that performs different processing; the collating unit 110 is replaced with a collating unit 2005 that performs different processing; and the display processing unit 109 is replaced with a display processing unit 2004 that performs different processing. In the following description, the same components as those in the first embodiment are denoted by the same reference numerals, and a description thereof is omitted.

The element-correspondence storing unit 2001 further stores therein the area-correspondence managing table to search for elements.

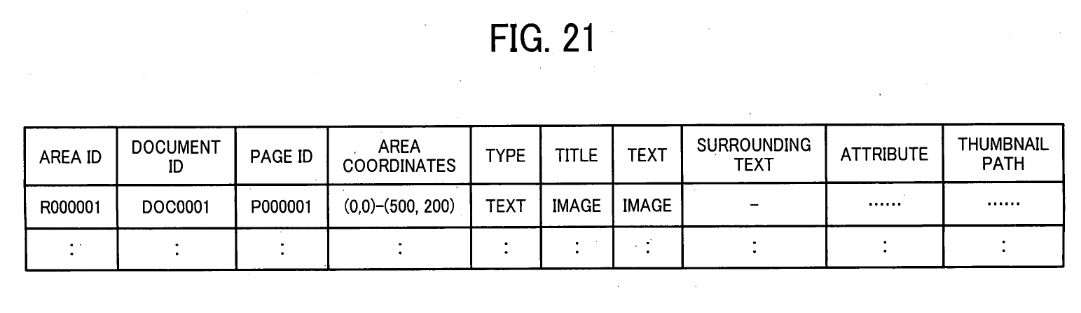

FIG. 21 is a diagram of an exemplary table structure of the area-correspondence managing table. The area-correspondence managing table stores therein an area ID, a document ID, a page ID, area coordinates, a type, a title, text, surrounding text, an attribute, and a thumbnail path such that these items are associated with one another.

The area ID is a unique ID assigned to each of the areas divided from document data. With this ID, the areas contained in document data managed by the document searching apparatus 2000 can be identified. The document ID and the page ID are IDs for identifying the document data and the page containing the relevant area. Area coordinates contain coordinates for locating the relevant area. In this embodiment, the desired area can be located based on the coordinates of the upper-left corner and the coordinates of the lower-right corner.

Type contains information for identifying the type of the data in the relevant area. The type of data includes, for example, text, image, and video. Title contains the title representing the relevant area. Text contains text information contained in the relevant area.

If the type of data is, for example, image, surrounding text contains text information disposed around the relevant image. By doing so, the user can specify a search criterion in the form of text on the search screen to search for an image related to the text.

Attribute contains the attribute for identifying the area. Furthermore, if the type is, for example, image, then attribute means the attribute of the image. If the type is text, then attribute means the text attribute. In this manner, attribute contains different types of attribute depending on the type. As a result, whether areas are similar to each other can be determined by comparing feature quantities of the same type. A method for extracting the attribute will be described later. The thumbnail path contains the location where the thumbnail representing the area is stored.

When a user selects an area as a search target on the search screen, the searching unit 2002 searches the area-correspondence managing table. When a search is made for areas, the searching unit 2002 searches the field “attribute” of the area-correspondence managing table and then finds the area IDs, the page IDs, the page numbers, the document IDs, and the thumbnail paths of the records satisfying the relevant search criterion. Other searching methods are the same as those described in the first embodiment, and a description thereof is omitted.

When the searching unit 2002 searches for areas, the document identifying unit 2003 identifies the pages and document data containing each of the found areas. The pages and document data containing the desired area can be identified based on the page IDs and the document IDs associated with the area ID in the area-correspondence managing table. Thus, the found areas can be displayed, classified by page or document data. Processing for searching for pages is the same as that described in the first embodiment, and a description thereof is omitted.

If a plurality of character strings are input as a search criterion and are found to be distributed on different pages or areas in document data or pages identified by the document identifying unit 2003 and the distance between the pages (in terms of the number of pages) or between the areas is larger than a predetermined value, then the deleting unit 2006 deletes the areas (or areas contained in pages if page numbers are used) from the search result produced by the searching unit 2002.

The collating unit 2005 classifies the areas after deletion has been performed by the deleting unit 2006 according to document data or page identified by the document identifying unit 2003.

The display processing unit 2004 includes a list-display processing unit 2011 and displays information on the display monitor 152.

The display processing unit 2004 differs from the display processing unit 109 according to the first embodiment in that if the search target is areas, they are displayed in units of document data or in units of pages, grouped by the collating unit 2005. If areas are displayed in units of documents, they are displayed in the same manner as in the first embodiment. On the other hand, when displaying areas in units of pages, the display processing unit 2004 classifies the areas by document data and then displays pages in order of page number. In this case, the display processing unit 2004 highlights the found areas.

When the selection receiving unit 112 has received selection of document data while the display processing unit 2004 displays pages, classified by document data, the list-display processing unit 2011 displays a list of pages containing the found areas from among the pages contained in the selected document data.

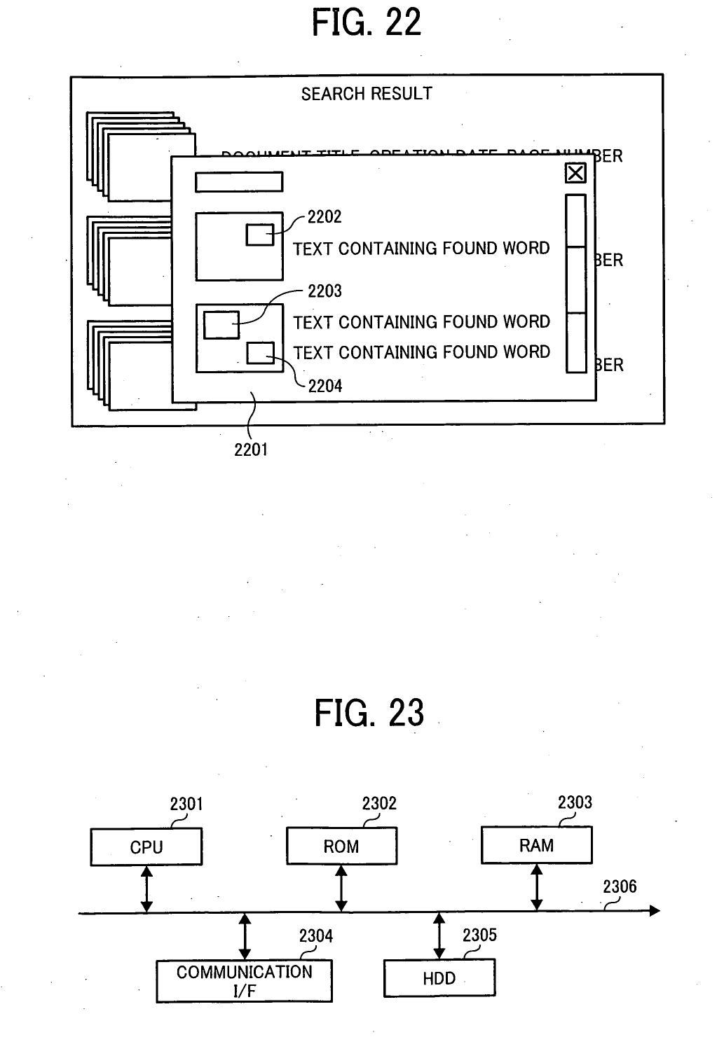

FIG. 22 is a diagram of an exemplary page list displayed by the list-display processing unit 2011 according to the second embodiment. Referring to FIG. 22, the list-display processing unit 2011 displays in a window 2201 the thumbnails and detailed information of the pages containing the areas that meet the search criterion. In this case, the list-display processing unit 2011 highlights areas 2202, 2203 and 2204 meeting the search criterion. The areas 2203 and 2204 show an example where two document elements have been found on a single page.

The document searching apparatus 2000 according to this embodiment has been described by way of an example where the areas are text. However, the present invention is also applicable if the areas are images.

Furthermore, in addition to the advantages afforded by the document searching apparatus 100, the document searching apparatus 2000 has an advantage in that areas contained in a document can be retrieved more easily and that the visibility is improved because the found areas are highlighted.

FIG. 23 is a diagram of an exemplary hardware structure of a PC that executes a computer program that realizes the functions of the document searching apparatuses 100 and 2000. The document searching apparatuses 100 and 2000 each include a control apparatus such as a central processing unit (CPU) 2301, memory devices such as a read only memory (ROM) 2302 and a random access memory (RAM) 2303, a hard disk drive (HDD) 2305 that stores therein, for example, document data, a communication interface (I/F) 2304, and a bus 2306 that connects these units. That is, the PC has the same hardware structure as a standard computer.

The document-searching program executed by the document searching apparatuses 100 and 2000 of the embodiments is a loadable or executable file and is provided stored on a computer-readable recording medium such as a CD-ROM, a flexible disk (FD), a CD-R, or a digital versatile disk (DVD).

Alternatively, the document-searching program executed by the document searching apparatuses 100 and 2000 of the embodiments may be stored in a computer connected to a network, such as the Internet, so that the document-searching program can be provided by downloading it via the network. Alternatively, the document-searching program executed by the document searching apparatuses 100 and 2000 of the embodiments may be provided or distributed via a network such as the Internet.

Alternatively, the document-searching program of the embodiments may be provided preinstalled in, for example, a ROM.

The document-searching program executed by the document searching apparatuses 100 and 2000 of the embodiments is composed of modules including the units described above (the operation processing unit, the registering unit, the searching unit, the document identifying unit, the deleting unit, and the display processing unit). In actual hardware, when the CPU reads out the document-searching program from the recording medium and executes it, each of the units is loaded in the RAM 2303, that is, the operation processing unit, the registering unit, the searching unit, the document identifying unit, the deleting unit, and the display processing unit are generated in the RAM 2303.

According to the present invention, because elements are displayed, classified by document information, the browsing efficiency is enhanced and a desired element can easily be identified.

Note 1. A document searching apparatus comprising:

means for storing therein document information and a plurality of elements constituting the document information in an associated manner;

means for searching and retrieving at least one element satisfying a search criterion from among the elements stored in the means for storing;

means for identifying document information associated with each of the elements retrieved by the means for searching and retrieving;

means for grouping each of the elements retrieved by the means for searching and retrieving according to the document information identified by the means for identifying; and

means for processing and displaying each of the elements grouped by the means for grouping according to the document information.

Note 2. The document searching apparatus according to note 1, further comprising means for deleting, wherein

the means for storing further stores therein an element number that indicates an ordinal number of each of the elements constituting the document information,

if the search criterion includes a plurality of character strings, the means for searching and retrieving retrieves at least one element containing at least one of the input character strings, and

if at least one of the character strings is contained in different elements of the document information identified by the means for identifying and if a difference between the different elements in terms of element number is larger than a predetermined value, the means for deleting deletes the different elements from the elements retrieved by the means for searching and retrieving.

Note 3. The document searching apparatus according to note 1 or 2, wherein

the elements stored in the means for storing is a page, and

the means for processing cascades pages retrieved by the means for searching and retrieving, classified according to the document information identified by the means for identifying.

Note 4. The document searching apparatus according to one of notes 1 to 3, further comprising:

means for receiving selection of a document information from among the document information displayed by the means for processing; and

means for displaying a list of pages of the document information whose selection is received by the means for receiving.

Note 5. The document searching apparatus according to one of note 1 to 3, further comprising:

means for receiving selection of a document information from among the document information displayed by the means for processing; and

means for receiving input of a search criterion for searching the document information displayed by the means for processing, wherein

the means for searching and retrieving retrieves at least one element satisfying the search criterion whose input is received by the means for receiving input, the at least one element being included in the document information selected by the means for receiving selection, from among the at least one element displayed by the means for processing.

Note 6. The document searching apparatus according to one of notes 1 to 3, further comprising:

means for receiving selection of a document information from among the document information displayed by the means for processing; and

means for receiving input of a search criterion for searching the document information displayed by the means for processing, wherein

the means for searching and retrieving retrieves at least one element satisfying the search criterion whose input is received by the means for receiving input, the at least one element being associated in the means for storing with the document information selected by the means for receiving selection.

Note 7. The document searching apparatus according to note 1, wherein

each of the elements is an area constituting a page of the document information,

the means for storing stores therein area-correspondence information that associates information of the area with the page of the document information and page-correspondence information that associates the page, page image information representing the page, and the document information,

the means for searching and retrieving searches information of the areas stored in the means for storing based on a search criterion, and

the means for processing displays information of at least one area retrieved by the means for searching and retrieving and page image information representing the page associated by the means for storing, the display being classified according to the document information identified by the means for identifying.

Note 8. The document searching apparatus according to note 7, wherein the means for processing displays the at least one area retrieved by the means for searching and retrieving such that the at least one retrieved area can be discriminated from another area in the page image information.
Note 9. A computer readable recording medium that stores therein a computer program which when executed on a computer causes the computer to execute:

storing document information and a plurality of elements constituting the document information in a storing unit in an associated manner;

searching and retrieving at least one element satisfying a search criterion from among the elements stored in the storing unit at the storing;

identifying document information associated with each of the elements retrieved at the searching and retrieving;

grouping each of the elements retrieved at the searching and retrieving according to the document information identified at the identifying; and

processing and displaying each of the elements grouped at the grouping according to the document information.

Note 10. The computer readable recording medium according to note 9, further comprising deleting, wherein

the storing includes further storing in the storing unit an element number that indicates an ordinal number of each of the elements constituting the document information,

if the search criterion includes a plurality of character strings, the searching and retrieving includes retrieving at least one element containing at least one of the input character strings, and

if at least one of the character strings is contained in different elements of the document information identified at the identifying and if a difference between the different elements in terms of element number is larger than a predetermined value, the deleting includes deleting the different elements from the elements retrieved at the searching and retrieving.

Note 11. The computer readable recording medium according to note 9 or 10, wherein

the elements stored at the storing in the storing unit is a page, and

the processing includes cascading pages retrieved at the searching and retrieving, classified according to the document information identified at the identifying.

Note 12. The computer readable recording medium according to one of notes 9 to 11, further comprising:

receiving selection of a document information from among the document information displayed at the processing; and

displaying a list of pages of the document information whose selection is received at the receiving.

Note 13. The computer readable recording medium according to one of notes 9 to 11, further comprising:

receiving selection of a document information from among the document information displayed at the processing; and

receiving input of a search criterion for searching the document information displayed at the processing, wherein

the searching and retrieving includes retrieving at least one element satisfying the search criterion whose input is received at the receiving input, the at least one element being included in the document information selected at the receiving selection, from among the at least one element displayed at the processing.

Note 14. The computer readable recording medium according to one of notes 9 to 11, further comprising:

receiving selection of a document information from among the document information displayed at the processing; and

receiving input of a search criterion for searching the document information displayed at the processing, wherein

the searching and retrieving includes retrieving at least one element satisfying the search criterion whose input is received at the receiving input, the at least one element being associated in the storing unit with the document information selected at the receiving selection.

Note 15. The computer readable recording medium according to note 9, wherein

each of the elements is an area constituting a page of the document information,

the storing includes storing in the storing unit area-correspondence information that associates information of the area with the page of the document information and page-correspondence information that associates the page, page image information representing the page, and the document information,

the searching and retrieving includes searching information of the areas stored in the storing unit based on a search criterion, and

the processing includes displaying information of at least one area retrieved at the searching and retrieving and page image information representing the page associated in the storing unit, the display being classified according to the document information identified at the identifying.

Note 16. The computer readable recording medium according to note 15, wherein the processing includes displaying the at least one area retrieved at the searching and retrieving such that the at least one retrieved area can be discriminated from another area in the page image information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A document searching apparatus comprising:
a correspondence storing unit that stores therein document information and a plurality of elements constituting the document information in an associated manner;
a searching unit that retrieves at least one element satisfying a search criterion from among the elements stored in the correspondence storing unit;
a document identifying unit that identifies document information associated with each of the elements retrieved by the searching unit;
a collating unit that groups each of the elements retrieved by the searching unit according to the document information identified by the document identifying unit; and
a display processing unit that displays each of the elements grouped by the collating unit according to the document information.

2. The document searching apparatus according to claim 1, further comprising a deleting unit, wherein
the correspondence storing unit further stores therein an element number that indicates an ordinal number of each of the elements constituting the document information,
if the search criterion includes a plurality of character strings, the searching unit retrieves at least one element containing at least one of the input character strings, and
if at least one of the character strings is contained in different elements of the document information identified by the document identifying unit and if a difference between the different elements in terms of element number is larger than a predetermined value, the deleting unit deletes the different elements from the elements retrieved by the searching unit.

3. The document searching apparatus according to claim 1, wherein
the elements stored in the correspondence storing unit is a page, and
the display processing unit cascades pages retrieved by the searching unit, classified according to the document information identified by the document identifying unit.

4. The document searching apparatus according to claim 1, further comprising:
a selection receiving unit that receives selection of a document information from among the document information displayed by the display processing unit; and
a list-displaying unit that displays a list of pages of the document information whose selection is received by the selection receiving unit.

5. The document searching apparatus according to claim 1, further comprising:
a selection receiving unit that receives selection of a document information from among the document information displayed by the display processing unit; and
an input receiving unit that receives input of a search criterion for searching the document information displayed by the display processing unit, wherein
the searching unit retrieves at least one element satisfying the search criterion whose input is received by the input receiving unit, the at least one element being included in the document information selected by the selection receiving unit, from among the at least one element displayed by the display processing unit.

6. The document searching apparatus according to claim 1, further comprising:
a selection receiving unit that receives selection of a document information from among the document information displayed by the display processing unit; and
an input receiving unit that receives input of a search criterion for searching the document information displayed by the display processing unit, wherein
the searching unit retrieves at least one element satisfying the search criterion whose input is received by the input receiving unit, the at least one element being associated in the correspondence storing unit with the document information selected by the selection receiving unit.

7. The document searching apparatus according to claim 1, wherein
each of the elements is an area constituting a page of the document information,
the correspondence storing unit stores therein area-correspondence information that associates information of the area with the page of the document information and page-correspondence information that associates the page, page image information representing the page, and the document information,
the searching unit searches information of the areas stored in the correspondence storing unit based on a search criterion, and
the display processing unit displays information of at least one area retrieved by the searching unit and page image information representing the page associated by the correspondence storing unit, the display being classified according to the document information identified by the document identifying unit.

8. The document searching apparatus according to claim 7, wherein the display processing unit displays the at least one area retrieved by the searching unit such that the at least one retrieved area can be discriminated from another area in the page image information.

9. A document searching apparatus comprising:
means for storing therein document information and a plurality of elements constituting the document information in an associated manner;
means for searching and retrieving at least one element satisfying a search criterion from among the elements stored in the means for storing;
means for identifying document information associated with each of the elements retrieved by the means for searching and retrieving;
means for grouping each of the elements retrieved by the means for searching and retrieving according to the document information identified by the means for identifying; and
means for processing and displaying each of the elements grouped by the means for grouping according to the document information.

10. A computer readable recording medium that stores therein a computer program which when executed on a computer causes the computer to execute:
storing document information and a plurality of elements constituting the document information in a storing unit in an associated manner;
searching and retrieving at least one element satisfying a search criterion from among the elements stored in the storing unit at the storing;
identifying document information associated with each of the elements retrieved at the searching and retrieving;
grouping each of the elements retrieved at the searching and retrieving according to the document information identified at the identifying; and
processing and displaying each of the elements grouped at the grouping according to the document information.
